(19) United States
(12) Patent Application Publication
(10) Pub. No.: US 2023/0327086 A1
(43) Pub. Date: Oct. 12, 2023

(54) SECONDARY BATTERY

(71) Applicant: MURATA MANUFACTURING CO., LTD., Kyoto (JP)

(72) Inventor: Naoki HAYASHI, Kyoto (JP)

(21) Appl. No.: 18/128,099

(22) Filed: Mar. 29, 2023

Related U.S. Application Data
(63) Continuation of application No. PCT/JP2021/043126, filed on Nov. 25, 2021.

(30) Foreign Application Priority Data
Dec. 2, 2020 (JP) 2020-200329

(51) Int. Cl. H01M 4/36; H01M 4/134; H01M 4/587; H01M 4/133; H01M 4/38; H01M 4/62; H01M 4/60; H01M 10/0525

(52) U.S. Cl. CPC H01M 4/366; H01M 4/133; H01M 4/134; H01M 4/386; H01M 4/587; H01M 4/606; H01M 4/622; H01M 4/623; H01M 10/0525

(57) ABSTRACT

A secondary battery includes a positive electrode, a negative electrode, and an electrolytic solution. The negative electrode includes a Si-based negative electrode active material and a negative electrode binder. The Si-based negative electrode active material includes an active material core and a covering material. The active material core includes a Si-containing compound. The covering material covers at least a portion of a surface of the active material core. The covering material has an elastic modulus lower than an elastic modulus of the negative electrode binder. The covering material has an elongation at break of 100% or higher, and has a recovery of 70% or higher after being stretched to an elongation at break of 100%.

### CROSS REFERENCE TO RELATED APPLICATIONS

The present application is a continuation of PCT Pat. Application No. PCT/JP2021/043126, filed on Nov. 25, 2021, which claims priority to Japanese patent application no. JP2020-200329, filed on Dec. 2, 2020, the entire contents of which are herein incorporated by reference.

### BACKGROUND

The present technology relates to a secondary battery.

In recent years, various kinds of electronic equipment, including mobile phones, have been widely used. Such widespread use has promoted development of a secondary battery as a power source that is smaller in size and lighter in weight and allows for a higher energy density. Influencing a battery characteristic, each configuration in the secondary battery has been considered in various ways.

For example, a silicon (Si)-containing compound is an attractive material for inserting an electrochemically active ion therein and is therefore drawing attention as a negative electrode active material of a secondary battery that allows for a greater battery capacity.

### SUMMARY

The present technology relates to a secondary battery.

However, the Si-containing compound can be greatly varied in volume by insertion and extraction of an electrochemically active ion. For such a reason, repeated charging and discharging can change an internal structure of an active material layer, and can thereby deteriorate a battery characteristic. Regarding a secondary battery using the Si-containing compound as a negative electrode active material, it is therefore desired to improve a cyclability characteristic in relation to repeated charging and discharging.

It is therefore desirable to provide a secondary battery that makes it possible to improve a cyclability characteristic.

A secondary battery according to an embodiment of the present technology includes a positive electrode, a negative electrode, and an electrolytic solution. The negative electrode includes a Si-based negative electrode active material and a negative electrode binder. The Si-based negative electrode active material includes an active material core and a covering material. The active material core includes a Si-containing compound. The covering material covers at least a portion of a surface of the active material core. The covering material has an elastic modulus lower than an elastic modulus of the negative electrode binder. The covering material has an elongation at break of 100% or higher, and has a recovery of 70% or higher after being stretched to an elongation at break of 100%.

According to the secondary battery of an embodiment of the present technology, at least a portion of the surface of the active material core including the Si-containing compound is covered with the covering material. The covering material has the elastic modulus lower than that of the negative electrode binder. The covering material has the elongation at break of 100% or higher, and has the recovery of 70% or higher after being stretched to the elongation at break of 100%. Thus, the secondary battery according to an embodiment allows the covering material to expand and contract in accordance with expansion and contraction of the active material core including the Si-containing compound, thus being able to help to prevent an internal structure of an active material layer from collapsing due to repeated charging and discharging. Accordingly, the secondary battery according to an embodiment makes it possible to improve a cyclability characteristic.

Note that effects of the present technology are not necessarily limited to those described herein and may include any of a series of suitable effects in relation to the present technology.

### BRIEF DESCRIPTION OF THE FIGURES

FIG. 1 is a sectional view of a configuration of a lithium-ion secondary battery (a cylindrical type) according to an embodiment of the present technology.

FIG. 2 is an enlarged sectional view of a configuration of a main part of the lithium-ion secondary battery illustrated in FIG. 1.

FIG. 3 is a perspective view of a configuration of another lithium-ion secondary battery (a laminated-film type) according to an embodiment.

FIG. 4 is an enlarged view of a configuration of a main part of the lithium-ion secondary battery illustrated in FIG. 3.

FIG. 5 is a block diagram illustrating a configuration of a battery pack that is an example of an application example of the secondary battery according to an embodiment.

FIG. 6 includes Table 1 referenced in the present disclosure.

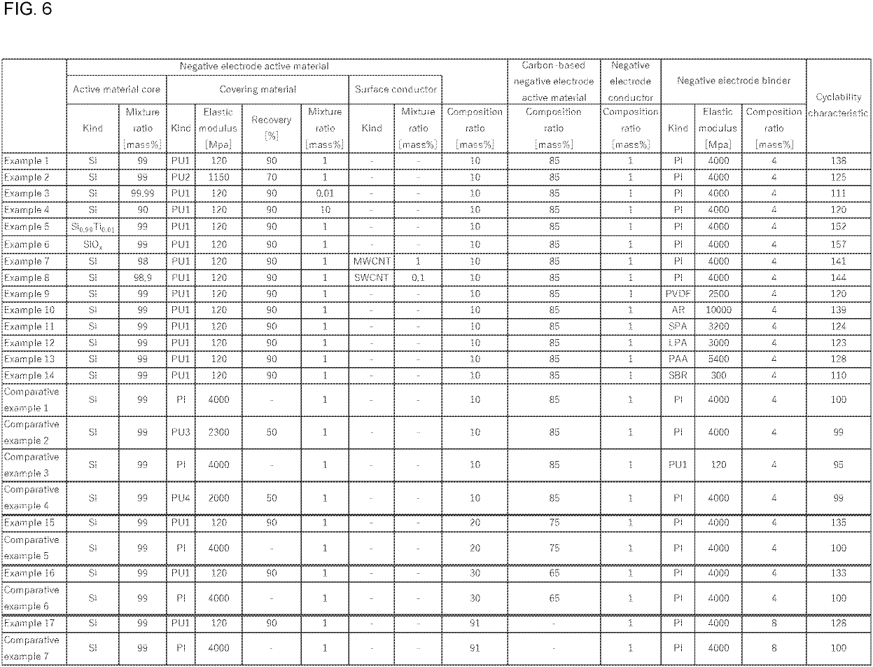

### DETAILED DESCRIPTION

One or more embodiments of the present technology are described below in further detail including with reference to the drawings.

A description is given of a secondary battery according to an embodiment of the present technology.

The secondary battery to be described here, in an embodiment, is a secondary battery that obtains a battery capacity using insertion and extraction of an electrode reactant, and includes a positive electrode, a negative electrode, and an electrolytic solution. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited, the electrode reactant is a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

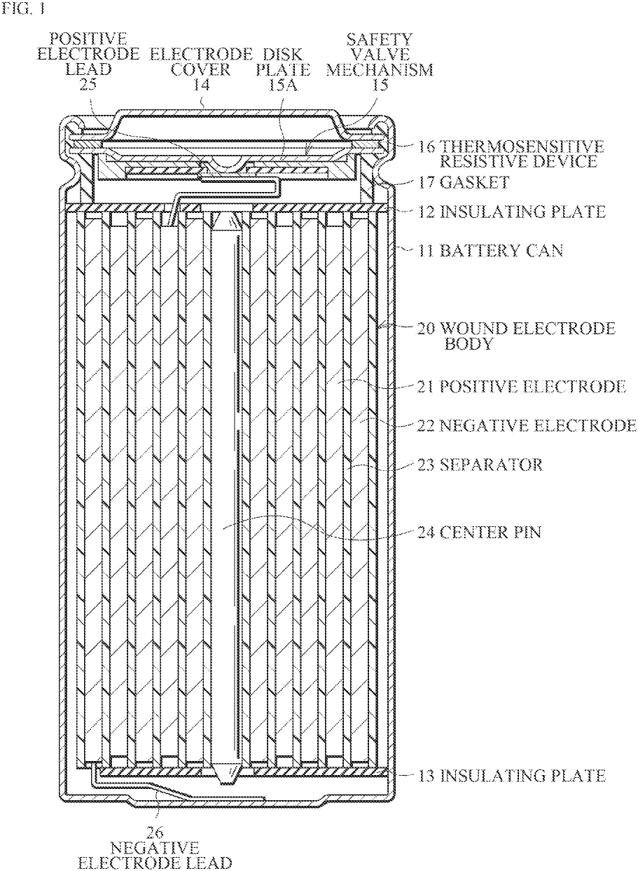

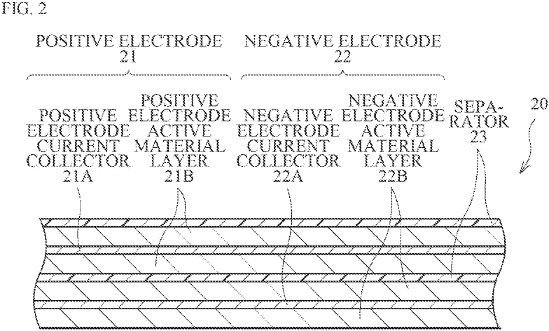

FIG. 1 is a sectional diagram illustrating a sectional configuration of the secondary battery. FIG. 2 is a sectional diagram illustrating, in an enlarged manner, of a sectional configuration of a main part (a wound electrode body 20) of the secondary battery illustrated in FIG. 1. Note that FIG. 2 illustrates only a portion of the wound electrode body 20.

The secondary battery illustrated in FIG. 1 is a lithium-ion secondary battery of a cylindrical type in which the wound electrode body 20 is contained inside a battery can 11 having a cylindrical shape. The wound electrode body 20 is a battery device.

For example, the secondary battery includes a pair of insulating plates 12 and 13 and the wound electrode body 20 that are provided in the battery can 11. The wound electrode body 20 is an electrode body resulting from winding a positive electrode 21 and a negative electrode 22 that are stacked on each other with a separator 23 interposed therebetween. The wound electrode body 20 is impregnated with an electrolytic solution. The electrolytic solution is a liquid electrolyte.

The battery can 11 includes one or more of materials including, without limitation, iron (Fe), aluminum (Al), and an alloy thereof. The battery can 11 has a hollow structure with a closed end and an open end. The battery can 11 has a surface that may be plated with, for example, nickel (Ni). The insulating plates 12 and 13 each extend in a direction intersecting a wound peripheral surface of the wound electrode body 20. The insulating plates 12 and 13 are disposed to be opposed to each other, sandwiching the wound electrode body 20 therebetween.

A battery cover 14, a safety valve mechanism 15, and a thermosensitive resistive device (a PTC device) 16 are crimped at the open end of the battery can 11 by means of a gasket 17. The open end of the battery can 11 is thereby sealed.

The battery cover 14 includes a material similar to a material included in the battery can 11. The safety valve mechanism 15 and the thermosensitive resistive device 16 are disposed on an inner side of the battery cover 14. The safety valve mechanism 15 is electrically coupled to the battery cover 14 via the thermosensitive resistive device 16. When an internal pressure of the battery can 11 reaches a certain level or higher due to any cause such as an internal short circuit or heating from outside, the safety valve mechanism 15 causes a disk plate 15A to invert, thereby cutting off the electrical coupling between the battery cover 14 and the wound electrode body 20. The thermosensitive resistive device 16 is a device having a resistance that increases with a rise in temperature. The thermosensitive resistive device 16 is provided in order to prevent abnormal heat generation resulting from a large current. The gasket 17 includes an insulating material. The gasket 17 may have a surface on which a material such as asphalt is applied.

A center pin 24 is disposed in a space provided at a winding center of the wound electrode body 20. Note that the center pin 24 may be omitted in some cases. A positive electrode lead 25 is coupled to the positive electrode 21. The positive electrode lead 25 includes one or more of electrically conductive materials including, without limitation, aluminum. The positive electrode lead 25 is electrically coupled to the battery cover 14 via the safety valve mechanism 15. A negative electrode lead 26 is coupled to the negative electrode 22. The negative electrode lead 26 includes one or more of electrically conductive materials including, without limitation, nickel. The negative electrode lead 26 is electrically coupled to the battery can 11.

As illustrated in FIG. 2, the positive electrode 21 includes a positive electrode current collector 21A, and two positive electrode active material layers 21B provided on respective opposite sides of the positive electrode current collector 21A. However, the positive electrode active material layer 21B may be provided only on one of the opposite sides of the positive electrode current collector 21A.

The positive electrode current collector 21A includes one or more of electrically conductive materials including, without limitation, aluminum, nickel, and stainless steel. The positive electrode current collector 21A may be single-layered or multi-layered.

The positive electrode active material layer 21B includes, as a positive electrode active material, one or more of positive electrode materials into which lithium is insertable and from which lithium is extractable. The positive electrode active material layer 21B may further include one or more of other materials including, without limitation, a positive electrode binder and a positive electrode conductor.

The positive electrode material is a lithium-containing compound that allows for a high energy density. The lithium-containing compound is not limited to a particular kind, and examples thereof include a lithium-containing composite oxide and a lithium-containing phosphoric acid compound.

The lithium-containing composite oxide is an oxide that has any of crystal structures including, without limitation, a layered rock-salt crystal structure and a spinel crystal structure and includes lithium and one or more of other elements as constituent elements. The lithium-containing phosphoric acid compound is a phosphoric acid compound that has a crystal structure such as an olivine crystal structure and includes lithium and one or more of other elements as constituent elements.

The other elements described above refer to elements other than lithium. The other elements described above are not limited to particular kinds as long as the other elements include any one or more elements. Specifically, in order to achieve a higher voltage, the other elements are preferably elements that belong to groups 2 to 15 in the long periodic table of elements. More specifically, the other elements are more preferably elements including, without limitation, nickel (Ni), cobalt (Co), manganese (Mn), and iron (Fe).

Examples of the lithium-containing composite oxide having the layered rock-salt crystal structure include respective compounds represented by Formulae (1) to (3) below.

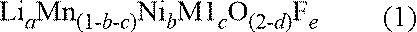

where:
M1 is at least one of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), or tungsten (W);
a to e satisfy 0.8 ≤ a ≤ 1.2, 0 < b < 0.5, 0 ≤ c ≤ 0.5, (b + c) < 1, -0.1 ≤ d ≤ 0.2, and 0 ≤ e ≤ 0.1;
a composition of lithium differs depending on a charge and discharge state; and
a is a value in a fully discharged state.

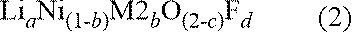

where:
   M2 is at least one of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W);
   a to d satisfy 0.8 ≤ a≤ 1.2, 0.005 ≤ b ≤ 0.5, -0.1 ≤ c ≤ 0.2, and 0 ≤ d ≤ 0.1;
   a composition of lithium differs depending on a charge and discharge state; and
   a is a value in a fully discharged state. 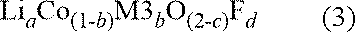
   where:
      M3 is at least one of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W);
      a to d satisfy 0.8 ≤ a ≤ 1.2, 0 ≤ b < 0.5, -0.1 ≤ c ≤ 0.2, and 0 ≤ d ≤ 0.1;
      a composition of lithium differs depending on a charge and discharge state; and
      a is a value in a fully discharged state.

Specific examples of the lithium-containing composite oxide having the layered rock-salt crystal structure include LiNiO₂, LiCoO₂, LiCo_{0.98}AlO_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{y}Mn_{y}Co_{y}NiyO₂, and Li_{1.15}(MnyNi_{0.22}Co_{y})O₂.

In a case where the lithium-containing composite oxide having the layered rock-salt crystal structure includes nickel (Ni), cobalt (Co), manganese (Mn), and aluminum (Al) as constituent elements, an atomic ratio of nickel (Ni) is preferably 50 atom% or greater in order to achieve a high energy density.

Examples of the lithium-containing composite oxide having the spinel crystal structure include a compound represented by Formula (4) below.

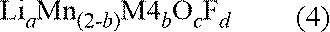

where:
M4 is at least one of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W);
a to d satisfy 0.9 ≤ a ≤ 1.1, 0 ≤ b ≤ 0.6, 3.7 ≤ c ≤ 4.1, and 0 ≤ d ≤ 0.1;
a composition of lithium differs depending on a charge and discharge state; and
a is a value in a fully discharged state.

Specific examples of the lithium-containing composite oxide having the spinel crystal structure include LiMn₂O₄.

Examples of the lithium-containing phosphoric acid oxide having the olivine crystal structure include a compound represented by Formula (5) below.

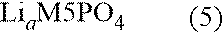

where:
M5 is at least one of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), or zirconium (Zr);
a satisfies 0.9 ≤ a ≤ 1.1;
a composition of lithium differs depending on a charge and discharge state; and
a is a value in a fully discharged state.

Specific examples of the lithium-containing phosphoric acid compound having the olivine crystal structure include LiFePO₄, LiMnPO₄, LiFe_{0.5}Mn_{0.5}PO₄, and LiFe_{0.3}Mn_{0.7}PO₄.

Note that the examples of the lithium-containing composite oxide may include a compound represented by Formula (6) below.

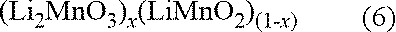

where:
x satisfies 0 ≤ x ≤ 1;
a composition of lithium differs depending on a charge and discharge state; and
x is a value in a fully discharged state.

Other than the above-described materials, the positive electrode material may be, for example, an oxide, a disulfide, a chalcogenide, or an electrically conductive polymer. Examples of the oxide include titanium oxide, vanadium oxide, and manganese dioxide. Examples of the disulfide include titanium disulfide and molybdenum sulfide. Examples of the chalcogenide include niobium selenide. Examples of the electrically conductive polymer include sulfur, polyaniline, and polythiophene.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride and polyimide.

The positive electrode conductor includes one or more of electrically conductive materials including, without limitation, a carbon material. Examples of the carbon material include graphite, carbon black, acetylene black, and Ketjen black. The positive electrode conductor may be a material such as a metal material or an electrically conductive polymer as long as the positive electrode conductor is an electrically conductive material.

As illustrated in FIG. 2, the negative electrode 22 includes a negative electrode current collector 22A, and two negative electrode active material layers 22B provided on respective opposite sides of the negative electrode current collector 22A. However, the negative electrode active material layer 22B may be provided only on one of the opposite sides of the negative electrode current collector 22A. Here, in order to prevent unintentional precipitation of a lithium metal on a surface of the negative electrode 22 during charging, a chargeable capacity of the negative electrode 22 is preferably greater than a discharge capacity of the positive electrode 21. In other words, an electrochemical equivalent of the negative electrode 22 is preferably greater than an electrochemical equivalent of the positive electrode 21.

The negative electrode current collector 22A includes one or more of electrically conductive materials including, without limitation, copper, aluminum, nickel, and stainless steel. The negative electrode current collector 22A may be single-layered or multi-layered.

The negative electrode current collector 22A preferably has a surface roughened by a method such as an electrolysis method. This makes it possible to improve the negative electrode current collector 22A in adherence to the negative electrode active material layer 22B by utilizing a so-called anchor effect.

The negative electrode active material layer 22B includes a Si-based negative electrode active material and a negative electrode binder. The Si-based negative electrode active material includes an active material core and a covering material.

The active material core is a center part of a primary particle of the Si-based negative electrode active material. The active material core includes one or more of Si-containing compounds into which lithium is insertable and from which lithium is extractable.

The Si-containing compound has superior lithium-ion insertion capacity and superior lithium-ion extraction capacity, and therefore allows for a markedly high energy density. The Si-containing compound may be a simple substance of silicon, an alloy of silicon, a compound of silicon, or a material including one or more phases thereof. The “simple substance” described here merely refers to a simple substance in a general sense. The simple substance may therefore include a small amount of impurity. That is, a purity of the simple substance is not necessarily limited to 100%.

The alloy of silicon includes, as one or more constituent elements other than silicon, one or more of metal elements including, without limitation, tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). The compound of silicon includes, as one or more constituent elements other than silicon, one or more of elements including, without limitation, carbon (C) and oxygen (0). In this case, carbon (C) may be included in a particle surface of silicon. Note that the compound of silicon may include, as one or more constituent elements other than silicon, one or more of the series of metal elements described in relation to the alloy of silicon.

Examples of the alloy of silicon and the compound of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0 < v ≤ 2), and LiSiO. Note that the range of v may be greater than 0.2 and less than 1.4.

The covering material covers at least a portion of a surface of the active material core. The covering material includes an organic resin having an elongation at break of 100% or higher and having a recovery of 70% or higher after being stretched to an elongation at break of 100%.

The elongation at break of 100% or higher refers to that, in a tensile test using a dumb-bell test piece based on JIS6251, the test piece is stretchable until a stretched amount becomes 100% or greater of the length before the test. To give an example, the elongation at break of 100% or higher refers to that a test piece (having a shape of dumb-bell No. 8) having a length of 16 mm is stretchable to have a length of 32 mm or greater.

The recovery of 70% or higher after being stretched to the elongation at break of 100% refers to that, likewise, in the tensile test using a dumb-bell test piece based on JIS6251, after the test piece is stretched until a stretched amount becomes 100% of the length before the test, the test piece is to contract to have the stretched amount of less than 30% of the length before the test (in other words, a contraction amount of the test piece is to be 70% or greater of the length before the test). To give an example, the recovery of 70% or higher after being stretched to the elongation at break of 100% refers to that if a test piece (having the shape of dumb-bell No. 8) having a length of 16 mm is stretched to have a length of 32 mm or greater and thereafter such stretching of the test piece is stopped, the test piece contracts to have a length of less than 20.8 mm.

The covering material is able to reduce active cites between the active material core and the electrolytic solution by covering at least a portion of the surface of the active material core including the Si-containing compound. Accordingly, the covering material makes it possible to suppress a side reaction of the electrolytic solution upon charging and discharging, and to thereby improve a cyclability characteristic of the secondary battery.

Further, the covering material is able to expand and contract in accordance with expansion and contraction of the active material core upon charging and discharging, by including the organic resin having the elongation at break of 100% or higher and the recovery of 70% or higher after being stretched to the elongation at break of 100% and thus having small tensile strain. Specifically, by including the organic resin having a high elongation at break and a high recovery after being stretched to the elongation at break of 100%, the covering material allows the negative electrode active material layer 22B to recover to its original state when the active material core expands and thereafter contracts. Accordingly, the covering material makes it possible to suppress reduction in contact between the Si-based negative electrode active materials caused by gradual expansion of the negative electrode active material layer 22B accompanying proceeding of repeated charging and discharging. The covering material is thus able to maintain minimum expansion and contraction of the negative electrode active material layer 22B and to help to prevent the internal structure of the negative electrode active material layer 22B from collapsing due to the expansion and contraction. The covering material therefore makes it possible to improve the cyclability characteristic of the secondary battery by suppressing deterioration of the structure of the negative electrode active material layer 22B upon charging and discharging.

Examples of such an organic resin having a small elongation strain include a polyurethane resin having an average molecular weight of 10000 or less, among polyurethane resins that are each a polymer of a polyolefin-based polyol and a polyisocyanate. However, the organic resin included in the covering material is not limited to the polyurethane resin described above. The organic resin included in the covering material may be another organic resin as long as the organic resin has the elongation at break of 100% or higher and has the recovery of 70% or higher after being stretched to the elongation at break of 100%.

At least a portion of the surface of the active material core may further be covered with a surface conductor. The surface conductor includes one or more of electrically conductive materials including, without limitation, a carbon material. The surface conductor is able to electrically couple the primary particles of the Si-based negative electrode active material with each other or secondary particles of the Si-based negative electrode active material to each other more firmly, thus helping to prevent an electrically conductive network of the Si-based negative electrode active material from collapsing due to the expansion and contraction of the active material core. The surface conductor is thus able to more firmly maintain the electrically conductive network formed inside the negative electrode active material layer 22B, thus making it possible to improve the cyclability characteristic of the secondary battery.

In addition, the surface conductor is able to decrease electric resistance, of the Si-based negative electrode active material, which has been increased due to the covering by the covering material. The surface conductor is also able to decrease electric resistance of the primary particles of the Si-based negative electrode active material which has been granulated. The surface conductor thus makes it possible to suppress deterioration of the cyclability characteristic of the secondary battery caused by an increase in electric resistance of the Si-based negative electrode active material.

The surface conductor is, for example, a carbon material such as carbon black, flake graphite, or a carbon nanotube. The surface conductor is preferably a carbon nanotube, and is more preferably a carbon nanotube having a smaller tube diameter. A reason for this is that, in a case where the surface conductor is a carbon nanotube, a smaller tube diameter of the carbon nanotube allows for similar effects even with a smaller added amount of the surface conductor.

The negative electrode binder includes one or more of materials each having an elastic modulus higher than that of the covering material covering the active material core of the Si-based negative electrode active material. Examples of the materials each having such an elastic modulus include a polymer compound and a synthetic rubber. By including the polymer compound and the synthetic rubber each having the elastic modulus higher than that of the covering material, the negative electrode binder is able to suppress an expansion amount of the negative electrode active material layer 22B as a whole, thus making it possible to improve the cyclability characteristic of the secondary battery. For example, in a case where the covering material is the polyurethane resin in which the polyolefin-based polyol and the polyisocyanate are polymerized with each other and which has the average molecular weight of 10000 or less, the negative electrode binder preferably includes a material such as polyvinylidene difluoride, a polyacrylic acid salt (such as sodium polyacrylate or lithium polyacrylate), polyimide, aramid, polyacrylamide, or a styrene-butadiene rubber.

Further, for the following reasons, the negative electrode active material layer 22B may include a carbon-based negative electrode active material including a carbon material, in addition to the Si-based negative electrode active material.

The term “carbon material” is a generic term for a material including carbon as a constituent element. The carbon material makes it possible to stably achieve a high energy density because the crystal structure of the carbon material hardly changes upon insertion and extraction of lithium. In addition, the carbon material makes it possible to improve electrical conductivity of the negative electrode active material layer 22B because the carbon material also serves as the negative electrode conductor.

Examples of the carbon material include graphitizable carbon, non-graphitizable carbon, artificial graphite, and natural graphite. Spacing of a (002) plane of the non-graphitizable carbon is preferably greater than or equal to 0.37 nm. Spacing of a (002) plane of each of the artificial graphite and the natural graphite is preferably smaller than or equal to 0.34 nm.

More specific examples of the carbon material include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is a resultant of firing or carbonizing a polymer compound such as a phenol resin or a furan resin at an appropriate temperature. In addition, the carbon material may be low-crystalline carbon heat-treated at a temperature of about 1000° C. or lower, or may be amorphous carbon. A shape of the carbon material may be any of shapes including, without limitation, a fibrous shape, a spherical shape, a granular shape, and a flake shape.

The metal-based material such as the Si-containing compound has an advantage of being high in theoretical capacity, but on the other hand, easily expands and contracts drastically upon charging and discharging. In contrast, the carbon material is low in theoretical capacity, but on the other hand, does not easily expand or contract upon charging and discharging. Accordingly, a combined use of the carbon material and the metal-based material makes it possible to achieve a high theoretical capacity (i.e., a high battery capacity) and to suppress expansion and contraction of the negative electrode active material layer 22B upon charging and discharging.

That is, the negative electrode active material layer 22B preferably includes both the Si-based negative electrode active material and the carbon-based negative electrode active material. In such a case, the secondary battery makes it possible to achieve a higher theoretical capacity and to further suppress the expansion and contraction of the negative electrode active material layer 22B upon charging and discharging.

As with the positive electrode active material layer 21B, the negative electrode active material layer 22B may further include another material such as a negative electrode conductor. As with the positive electrode conductor described above, the negative electrode conductor includes one or more of electrically conductive materials including, without limitation, a carbon material. Examples of the carbon material include graphite, carbon black, acetylene black, and Ketjen black. However, the negative electrode conductor may be a material such as a metal material or an electrically conductive polymer as long as the negative electrode conductor is an electrically conductive material.

As illustrated in FIG. 2, the separator 23 is interposed between the positive electrode 21 and the negative electrode 22. The separator 23 prevents a short circuit due to contact between the positive electrode 21 and the negative electrode 22 from occurring and allows lithium ions to pass therethrough.

The separator 23 includes one or more of porous films including, without limitation, a porous film including a synthetic resin and a porous film including ceramics. The separator 23 may be a stacked film in which two or more porous films are stacked on each other. Examples of the synthetic resin include polytetrafluoroethylene, polypropylene, and polyethylene.

The separator 23 may include the porous film described above and a polymer compound layer. The porous film serves as a base layer. The polymer compound layer may be provided on one of opposite sides of the base layer or on each of the opposite sides of the base layer. This allows the separator 23 to improve in adhesion to each of the positive electrode 21 and the negative electrode 22, thus allowing the wound electrode body 20 to further resist being distorted. Allowing the wound electrode body 20 to resist being distorted suppresses a decomposition reaction of the electrolytic solution and also suppresses leakage of the electrolytic solution with which the base layer is impregnated. Accordingly, the secondary battery makes it possible to suppress an increase in resistance and suppress swelling upon repeated charging and discharging.

The polymer compound layer includes one or more of polymer compounds that have superior physical strength and are electrochemically stable. Examples of such polymer compounds include polyvinylidene difluoride. In order to improve safety, the polymer compound layer may include one or more kinds of insulating particles, including without limitation, inorganic particles. The inorganic particles are not limited to a particular kind, and examples thereof include particles of aluminum oxide and particles of aluminum nitride.

The electrolytic solution includes materials including, without limitation, a solvent and an electrolyte salt. The wound electrode body 20 is impregnated with the electrolytic solution, as described above. That is, the separator 23 is impregnated with the electrolytic solution, and each of the positive electrode 21 and the negative electrode 22 is also impregnated with the electrolytic solution.

The solvent includes one or more of non-aqueous solvents (organic solvents). An electrolytic solution including a non-aqueous solvent is a so-called non-aqueous electrolytic solution.

Examples of the non-aqueous solvent include a cyclic carbonic acid ester, a chain carbonic acid ester, a chain carboxylic acid ester, a lactone, and a nitrile (mononitrile) compound. The secondary battery thus makes it possible to achieve superior characteristics including, without limitation, a superior battery capacity, a superior cyclability characteristic, and a superior storage characteristic.

Examples of the cyclic carbonic acid ester include ethylene carbonate, propylene carbonate, and butylene carbonate. Examples of the chain carbonic acid ester include dimethyl carbonate, diethyl carbonate, ethyl methyl carbonate, and methyl propyl carbonate. Examples of the lactone include γ-butyrolactone and γ-valerolactone. Examples of the chain carboxylic acid ester include methyl acetate, ethyl acetate, methyl propionate, ethyl propionate, propyl propionate, methyl butyrate, methyl isobutyrate, methyl trimethyl acetate, and ethyl trimethyl acetate. Examples of the nitrile include acetonitrile, methoxy acetonitrile, and 3-methoxy propionitrile.

Other than the above, examples of the solvent may include 1,2-dimethoxy ethane, tetrahydrofuran, 2-methyl tetrahydrofuran, tetrahydropyran, 1,3-dioxolane, 4-methyl-1,3-dioxolane, 1,3-dioxane, 1,4-dioxane, N,N-dimethyl formamide, N-methyl pyrrolidinone, N-methyl oxazolidinone, N,N′-dimethyl imidazolidinone, nitromethane, nitroethane, sulfolane, trimethyl phosphate, and dimethyl sulfoxide. The secondary battery is able to achieve similar advantages in a case where any of these solvents is used.

In particular, in order to achieve characteristics including, without limitation, a further superior battery capacity, a further superior cyclability characteristic, and a further superior storage characteristic, the solvent preferably includes one or more of ethylene carbonate, propylene carbonate, dimethyl carbonate, diethyl carbonate, and ethyl methyl carbonate.

In such a case, the solvent more preferably includes a combination of: the cyclic carbonic acid ester which is a solvent having a high viscosity or a high dielectric constant (specific dielectric constant ε ≥ 30); and the chain carbonic acid ester which is a solvent having a low viscosity (viscosity <_ 1 mPa·s). Examples of such a cyclic carbonic acid ester include ethylene carbonate and propylene carbonate. Examples of such a chain carbonic acid ester include dimethyl carbonate, ethyl methyl carbonate, and diethyl carbonate. The solvent thus makes it possible to improve a dissociation property of the electrolyte salt and ion mobility.

In addition, the solvent may include a material such as an unsaturated cyclic carbonic acid ester, a halogenated carbonic acid ester, a sulfonic acid ester, an acid anhydride, a dinitrile compound, or a diisocyanate compound. In such a case, the solvent is able to improve chemical stability of the electrolytic solution, making it possible to suppress, for example, a decomposition reaction of the electrolytic solution.

The unsaturated cyclic carbonic acid ester is a cyclic carbonic acid ester having one or more unsaturated bonds (carbon-carbon double bonds). Specific examples of the unsaturated cyclic carbonic acid ester include vinylene carbonate (1,3-dioxol-2-one), vinyl ethylene carbonate (4-vinyl-1,3-dioxolane-2-one), and methylene ethylene carbonate (4-methylene-1,3-dioxolane-2-one). A content of the unsaturated cyclic carbonic acid ester in the solvent is not particularly limited, and may be within a range from 0.01 mass% to 10 mass% both inclusive.

The halogenated carbonic acid ester is a cyclic or chain carbonic acid ester including one or more of halogens as one or more constituent elements. The halogen is not limited to a particular kind, and one or more of halogens including, without limitation, fluorine, chlorine, bromine, and iodine are usable. Specific examples of the cyclic halogenated carbonic acid ester include 4-fluoro-1,3-dioxolane-2-one and 4,5-difluoro-1,3-dioxolane-2-one. Specific examples of the chain halogenated carbonic acid ester include fluoromethyl methyl carbonate, bis(fluoromethyl) carbonate, and difluoromethyl methyl carbonate. A content of the halogenated carbonic acid ester in the solvent is not particularly limited, and may be within a range from 0.01 mass% to 50 mass% both inclusive.

Examples of the sulfonic acid ester include monosulfonic acid ester and disulfonic acid ester. The monosulfonic acid ester may be a cyclic monosulfonic acid ester or a chain monosulfonic acid ester. Specific examples of the cyclic monosulfonic acid ester include a sultone such as 1,3-propane sultone or 1,3-propene sultone. The chain monosulfonic acid ester is, for example, a compound resulting from the cyclic monosulfonic acid ester being cut at some middle point. The disulfonic acid ester may be a cyclic disulfonic acid ester or a chain disulfonic acid ester. A content of the sulfonic acid ester in the solvent is not particularly limited, and may be within a range from 0.5 mass% to 5 mass% both inclusive.

Examples of the acid anhydride include a carboxylic acid anhydride, a disulfonic acid anhydride, and a carboxylic acid sulfonic acid anhydride. Specific examples of the carboxylic acid anhydride include succinic anhydride, glutaric anhydride, and maleic anhydride. Specific examples of the disulfonic acid anhydride include ethanedisulfonic anhydride and propanedisulfonic anhydride. Specific examples of the carboxylic acid sulfonic acid anhydride include sulfobenzoic anhydride, sulfopropionic anhydride, and sulfobutyric anhydride. A content of the acid anhydride in the solvent is not particularly limited, and may be within a range from 0.5 mass% to 5 mass% both inclusive.

The dinitrile compound is a compound represented by NC—CₘH₂ₘ—CN (where m is an integer of 1 or greater). Specific examples of the dinitrile compound include succinonitrile (NC—C₂H₄—CN), glutaronitrile (NC—C₃H₆—CN), adiponitrile (NC—C₄H₈—CN), and phthalonitrile (NC—C₆H₄—CN). A content of the dinitrile compound in the solvent is not particularly limited, and may be within a range from 0.5 mass% to 5 mass% both inclusive.

The diisocyanate compound is a compound represented by OCN—CₙH₂ₙ—NCO (where n is an integer of 1 or greater). Specific examples of the diisocyanate compound include OCN—C₆H₁₂—NCO. A content of the diisocyanate compound in the solvent is not particularly limited, and may be within a range from 0.5 mass% to 5 mass% both inclusive.

The electrolyte salt includes one or more of lithium salts. However, the electrolyte salt may include a salt other than the lithium salt. Examples of the salt other than the lithium salt include a salt of a light metal other than lithium.

Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In a case where such a lithium salt is used, the secondary battery is able to achieve superior characteristics including, without limitation, a superior battery capacity, a superior cyclability characteristic, and a superior storage characteristic.

In particular, the electrolyte salt preferably includes one or more of lithium hexafluorophosphate, lithium tetrafluoroborate, lithium perchlorate, and lithium hexafluoroarsenate, and more preferably includes lithium hexafluorophosphate. In such a case, the electrolyte salt is able to decrease internal resistance, thus making it possible to further improve a battery characteristic of the secondary battery.

A content of the electrolyte salt is not particularly limited. However, in order to achieve high ionic conductivity, the content of the electrolyte salt is preferably within a range from 0.3 mol/kg to 3.0 mol/kg both inclusive with respect to the solvent.

The secondary battery according to an embodiment is able to perform a charging and discharging operation in the following manner.

Specifically, upon charging, the secondary battery allows lithium ions to be extracted from the positive electrode 21 and allows the extracted lithium ions to be inserted into the negative electrode 22 via the electrolytic solution. In contrast, upon discharging, the secondary battery allows lithium ions to be extracted from the negative electrode 22 and allows the extracted lithium ions to be inserted into the positive electrode 21 via the electrolytic solution. In such a manner, the secondary battery is able to perform the charging and discharging operation repeatedly.

The secondary battery according to an embodiment is manufacturable by the following procedure. Specifically, after fabrication of the positive electrode 21 and fabrication of the negative electrode 22 are performed, assembly of the lithium-ion secondary battery is performed.

First, the positive electrode active material is mixed with materials including, without limitation, the positive electrode binder and the positive electrode conductor on an as-needed basis to thereby prepare a positive electrode mixture. Thereafter, the positive electrode mixture is dispersed or dissolved in a solvent such as an organic solvent to thereby prepare a positive electrode mixture slurry in a paste form. Thereafter, the positive electrode mixture slurry is applied on opposite sides of the positive electrode current collector 21A, following which the applied positive electrode mixture slurry is dried to thereby form the positive electrode active material layers 21B. The positive electrode active material layers 21B may be compression-molded by means of a machine such as a roll pressing machine. In this case, the positive electrode active material layers 21B may be heated. The positive electrode active material layers 21B may be compression-molded multiple times.

The negative electrode 22 is fabricable by a procedure similar to the fabrication procedure of the positive electrode 21 described above.

Specifically, first, the Si-based negative electrode active material and the negative electrode binder are mixed with materials including, without limitation, the carbon-based negative electrode active material and the negative electrode conductor on an as-needed basis to thereby prepare a negative electrode mixture. Thereafter, the negative electrode mixture is dispersed or dissolved in a solvent such as an organic solvent to thereby prepare a negative electrode mixture slurry in a paste form. Thereafter, the negative electrode mixture slurry is applied on opposite sides of the negative electrode current collector 22A, following which the applied negative electrode mixture slurry is dried to thereby form the negative electrode active material layers 22B. The negative electrode active material layers 22B may be compression-molded.

First, the positive electrode lead 25 is coupled to the positive electrode current collector 21A by a method such as a welding method, and the negative electrode lead 26 is similarly coupled to the negative electrode current collector 22A by a method such as a welding method. Thereafter, the positive electrode 21 and the negative electrode 22 are stacked on each other with the separator 23 interposed therebetween, following which the positive electrode 21, the negative electrode 22, and the separator 23 are wound to thereby form a wound body. Thereafter, the center pin 24 is placed into the space provided at the winding center of the wound body.

Thereafter, the wound body is interposed between the pair of insulating plates 12 and 13, and the wound body in that state is contained in the battery can 11 together with the insulating plates 12 and 13. In this case, the positive electrode lead 25 is coupled to the safety valve mechanism 15 by a method such as a welding method, and the negative electrode lead 26 is coupled to the battery can 11 by a method such as a welding method. Thereafter, the electrolytic solution is injected into the battery can 11 to thereby impregnate the wound body with the electrolytic solution. Thus, the positive electrode 21, the negative electrode 22, and the separator 23 are each impregnated with the electrolytic solution. As a result, the wound electrode body 20 is formed.

Thereafter, the open end of the battery can 11 is crimped by means of the gasket 17 to thereby attach the battery cover 14, the safety valve mechanism 15, and the thermosensitive resistive device 16 to the open end of the battery can 11. Thus, the wound electrode body 20 is sealed in the battery can 11. As a result, the secondary battery is completed.

According to the secondary battery described above, the covering material expands and contracts in accordance with the expansion and contraction of the active material core including the Si-containing compound. It is thus possible to suppress the expansion and contraction of the negative electrode active material layer 22B to the minimum. This suppresses deterioration of the internal structure of the negative electrode active material layer 22B of the secondary battery. Accordingly, the secondary battery is able to achieve a high energy density owing to the Si-containing compound and to achieve a further higher cyclability characteristic.

Next, a description is given of a secondary battery according to another embodiment of the present technology. In the following, the description is given referring to the already-described components of the secondary battery of the cylindrical type (see FIGS. 1 and 2).

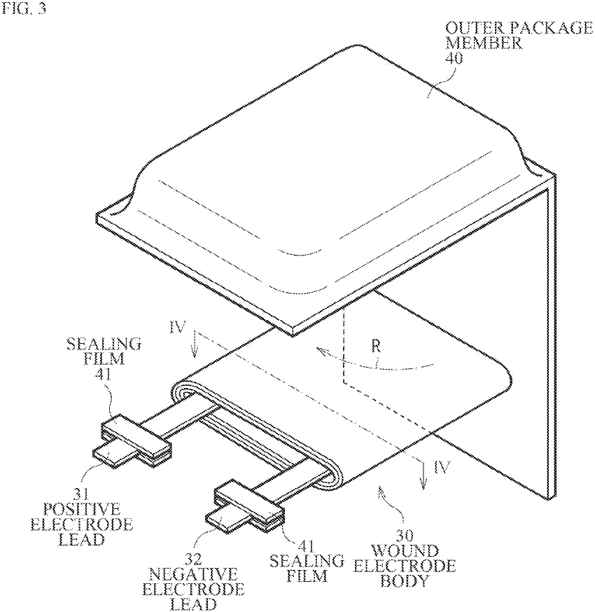

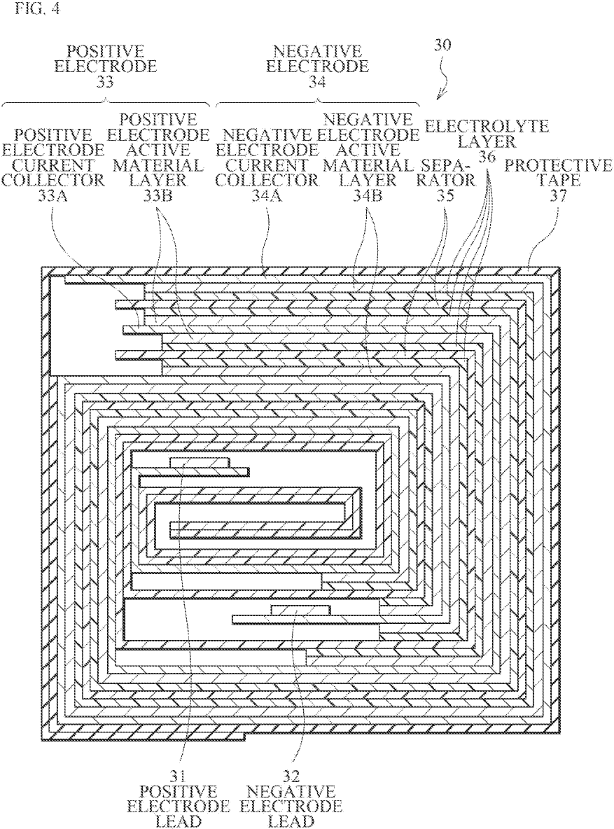

FIG. 3 illustrates a perspective configuration of the secondary battery of a laminated-film type. FIG. 4 illustrates a sectional configuration of a main part (a wound electrode body 30) of the secondary battery illustrated in FIG. 3, taken along a line IV-IV. Note that FIG. 3 illustrates a state in which the wound electrode body 30 and an outer package member 40 are separated away from each other.

The secondary battery illustrated in FIG. 3 is a lithium-ion secondary battery of the laminated-film type in which the wound electrode body 30 is contained inside the outer package member 40. The wound electrode body 30 is the battery device. The outer package member 40 has a film shape and has softness or flexibility.

The wound electrode body 30 is a wound body in which: a positive electrode 33 and a negative electrode 34 are stacked on each other with a separator 35 and an electrolyte layer 36 interposed therebetween; and the positive electrode 33 and the negative electrode 34 in such a state are wound. The wound electrode body 30 is protected by a protective tape 37. The electrolyte layer 36 is interposed between the positive electrode 33 and the separator 35, and is also interposed between the negative electrode 34 and the separator 35.

A positive electrode lead 31 is coupled to the positive electrode 33. The positive electrode lead 31 is led out from inside to outside of the outer package member 40. The positive electrode lead 31 includes one or more of electrically conductive materials including, without limitation, aluminum. The positive electrode lead 31 has any shape among shapes including, without limitation, a thin-plate shape and a meshed shape.

A negative electrode lead 32 is coupled to the negative electrode 34. The negative electrode lead 32 is led out from the inside to the outside of the outer package member 40 in a direction similar to a direction in which the positive electrode lead 31 is led out. The negative electrode lead 32 includes one or more of electrically conductive materials including, without limitation, copper, nickel, and stainless steel. The negative electrode lead 32 has a shape similar to that of the positive electrode lead 31.

The outer package member 40 is a single film that is foldable in a direction of an arrow R illustrated in FIG. 3. The outer package member 40 includes a portion having a depression 40U. The depression 40U is adapted to receive the wound electrode body 30.

The outer package member 40 is a laminated body (a laminated film) including a fusion-bonding layer, a metal layer, and a surface protective layer that are laminated in this order. The secondary battery has a configuration resulting from: folding the outer package member 40 in such a manner that portions of the fusion-bonding layer are opposed to each other with the wound electrode body 30 interposed therebetween; and fusion-bonding outer edge parts of the fusion-bonding layer to each other. The fusion-bonding layer is a film that includes one or more of polymer compounds including, without limitation, polypropylene. The metal layer is, for example, a metal foil that includes one or more of metal materials including, without limitation, aluminum. The surface protective layer is a film that includes one or more of polymer compounds including, without limitation, nylon. The outer package member 40 may include two laminated bodies (laminated films) described above, which may be adhered to each other by means of a material such as an adhesive.

A sealing film 41 is interposed between the outer package member 40 and the positive electrode lead 31 in order to prevent entry of outside air. A sealing film 42 is interposed between the outer package member 40 and the negative electrode lead 32 in a manner similar to that of the sealing film 41. The sealing film 41 includes a material having adherence to the positive electrode lead 31. The sealing film 42 includes a material having adherence to the negative electrode lead 32. Specifically, the sealing films 41 and 42 may each include one or more of polyolefin resins including, without limitation, polyethylene, polypropylene, modified polyethylene, and modified polypropylene.

The positive electrode 33 includes a positive electrode current collector 33A and a positive electrode active material layer 33B. The negative electrode 34 includes a negative electrode current collector 34A and a negative electrode active material layer 34B. The positive electrode current collector 33A, the positive electrode active material layer 33B, the negative electrode current collector 34A, and the negative electrode active material layer 34B respectively have configurations similar to those of the positive electrode current collector 21A, the positive electrode active material layer 21B, the negative electrode current collector 22A, and the negative electrode active material layer 22B. The separator 35 has a configuration similar to that of the separator 23.

The electrolyte layer 36 includes an electrolytic solution and a polymer compound. The electrolytic solution has a configuration similar to that of the electrolytic solution used in the lithium-ion secondary battery of the cylindrical type.

The electrolyte layer 36 is a so-called gel electrolyte. Thus, the electrolyte layer 36 allows the electrolytic solution to be held by the polymer compound, thereby allowing for high ionic conductivity (of about 1 mS/cm or higher at room temperature) and preventing leakage of the electrolytic solution from occurring. The electrolyte layer 36 may further include one or more of other materials including, without limitation, various additives.

The polymer compound includes a homopolymer, a copolymer, or both. Examples of the homopolymer include polyacrylonitrile, polyvinylidene difluoride, polytetrafluoroethylene, and polyhexafluoropropylene. Examples of the copolymer include a copolymer of vinylidene fluoride and hexafluoropylene.

Regarding the electrolyte layer 36 which is a gel electrolyte, a “solvent” included in the electrolytic solution encompasses not only a liquid material but also an ion-conductive material that is able to dissociate the electrolyte salt. Accordingly, an ion-conductive polymer compound is also encompassed by the “solvent” described above.

Note that the electrolytic solution may be used as it is instead of the electrolyte layer 36. In such a case, the wound electrode body 30 (the positive electrode 33, the negative electrode 34, and the separator 35) is impregnated with the electrolytic solution.

The secondary battery including the electrolyte layer 36 is able to perform a charging and discharging operation in the following manner. Specifically, upon charging, the secondary battery allows lithium ions to be extracted from the positive electrode 33 and allows the extracted lithium ions to be inserted into the negative electrode 34 via the electrolyte layer 36. In contrast, upon discharging, the secondary battery allows lithium ions to be extracted from the negative electrode 34 and allows the extracted lithium ions to be inserted into the positive electrode 33 via the electrolyte layer 36. In such a manner, the secondary battery is able to perform the charging and discharging operation repeatedly.

The secondary battery including the electrolyte layer 36 is manufacturable by any of the following three kinds of procedures according to an embodiment.

### First Procedure

First, the positive electrode 33 and the negative electrode 34 are fabricated by procedures similar to the procedures of fabricating the positive electrode 21 and the negative electrode 22 described above, respectively. Specifically, the positive electrode active material layer 33B is formed on each of opposite sides of the positive electrode current collector 33A to thereby form the positive electrode 33. Further, the negative electrode active material layer 34B is formed on each of opposite sides of the negative electrode current collector 34A to thereby form the negative electrode 34.

Thereafter, the electrolytic solution, the polymer compound, and a material such as an organic solvent are mixed with each other to thereby prepare a precursor solution. Thereafter, the precursor solution is applied on the positive electrode 33, following which the applied precursor solution is dried to thereby form the electrolyte layer 36. In a similar manner, the precursor solution is applied on the negative electrode 34, following which the applied precursor solution is dried to thereby form the electrolyte layer 36.

Thereafter, the positive electrode lead 31 is coupled to the positive electrode current collector 33A by a method such as a welding method. In a similar manner, the negative electrode lead 32 is coupled to the negative electrode current collector 34A by a method such as a welding method. Thereafter, the positive electrode 33 and the negative electrode 34 are stacked on each other with the separator 35 interposed therebetween, following which the positive electrode 33, the negative electrode 34, and the separator 35 are wound to thereby form the wound electrode body 30. Thereafter, the protective tape 37 is attached to the surface of the wound electrode body 30.

Thereafter, the outer package member 40 is folded in such a manner as to sandwich the wound electrode body 30, following which the outer edge parts of the outer package member 40 are bonded to each other by a method such as a thermal-fusion-bonding method. In this case, the sealing film 41 is interposed between the positive electrode lead 31 and the outer package member 40, and the sealing film 42 is interposed between the negative electrode lead 32 and the outer package member 40. As a result, the secondary battery of the laminated-film type in which the wound electrode body 30 is sealed in the outer package member 40 is completed.

### Second Procedure

First, the positive electrode 33 and the negative electrode 34 are fabricated. Thereafter, the positive electrode lead 31 is coupled to the positive electrode 33, and the negative electrode lead 32 is coupled to the negative electrode 34. Thereafter, the positive electrode 33 and the negative electrode 34 are stacked on each other with the separator 35 interposed therebetween, following which the positive electrode 33, the negative electrode 34, and the separator 35 are wound to thereby form a wound body. Thereafter, the protective tape 37 is attached to a surface of the wound body. Thereafter, the outer package member 40 is folded in such a manner as to sandwich the wound body, following which the outer edge parts, excluding the outer edge part of one side, of an outer periphery of the outer package member 40 are bonded to each other by a method such as a thermal-fusion-bonding method. Thus, the wound body is contained inside the outer package member 40 having a pouch shape.

Thereafter, the electrolytic solution, monomers, a polymerization initiator, and on an as-needed basis, another material such as a polymerization inhibitor are mixed with each other to thereby prepare a composition for electrolyte. The monomers are raw materials of the polymer compound. Thereafter, the composition for electrolyte is injected into the outer package member 40 having the pouch shape, following which the outer package member 40 is sealed by a method such as a thermal-fusion-bonding method. Thereafter, the monomers are thermally polymerized to thereby form the polymer compound. This allows the electrolytic solution to be held by the polymer compound, thereby forming the electrolyte layer 36. As a result, the secondary battery of the laminated-film type in which the wound electrode body 30 is sealed in the outer package member 40 is completed.

### Third Procedure

First, a wound body is fabricated and the wound body is contained inside the outer package member 40 having the pouch shape by a procedure similar to the second procedure, except for using the separator 35 that includes the base layer and the polymer compound layer provided on the base layer. Thereafter, the electrolytic solution is injected into the outer package member 40, following which an opening of the outer package member 40 is sealed by a method such as a thermal-fusion-bonding method. Thereafter, the outer package member 40 is heated, with a weight being applied to the outer package member 40, to thereby bring the separator 35 into close contact with each of the positive electrode 33 and the negative electrode 34 with the polymer compound layer interposed therebetween. The polymer compound layer impregnated with the electrolytic solution is thus gelated, forming the electrolyte layer 36. As a result, the secondary battery of the laminated-film type in which the wound electrode body 30 is sealed in the outer package member 40 is completed.

The third procedure helps to prevent the secondary battery from swelling easily, as compared with the first procedure. As compared with the second procedure, the third procedure helps to prevent the solvent and the monomers (the raw materials of the polymer compound) from easily remaining in the electrolyte layer 36, making it possible to favorably control the process of forming the polymer compound. This makes it easier for the electrolyte layer 36 to sufficiently come into close contact with each of the positive electrode 33, the negative electrode 34, and the separator 35.

According to the secondary battery described above, the covering material expands and contracts in accordance with the expansion and contraction of the active material core including the Si-containing compound. It is thus possible to suppress the expansion and contraction of the negative electrode active material layer 22B to the minimum. This suppresses deterioration of the internal structure of the negative electrode active material layer 22B of the secondary battery. Accordingly, the secondary battery is able to achieve a high energy density owing to the Si-containing compound and to achieve a further higher cyclability characteristic.

Other action and effects related the secondary battery of the laminated-film type are similar to those related to the secondary battery of the cylindrical type.

Applications (application examples) of the secondary battery are not particularly limited. The secondary battery used as a power source may be used as a main power source or an auxiliary power source of, for example, electronic equipment and electric vehicles. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use, for accumulation of electric power for a situation such as emergency. In such applications, a single secondary battery may be used, or multiple secondary batteries may be used.

The battery pack may include a single battery, or may include an assembled battery. The electric vehicle is a vehicle that operates (travels) using the secondary battery as a driving power source, and may be a hybrid automobile that is additionally provided with a driving source other than the secondary battery. The electric power storage system for home use allows for utilization of electric power accumulated in the secondary battery which is an electric power storage source to cause, for example, home appliances to operate.

An application example of the secondary battery will now be described in detail. The configuration of the application example described below is merely an example, and is appropriately modifiable.

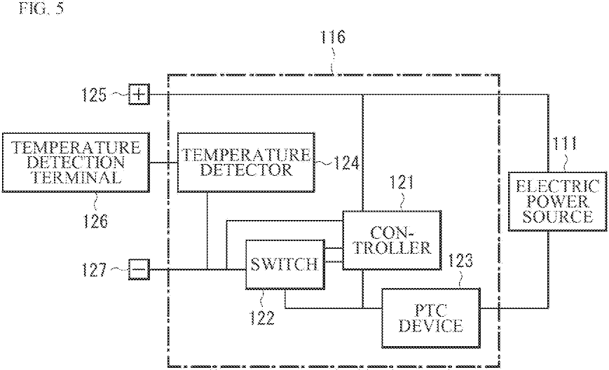

FIG. 5 illustrates a block configuration of a battery pack. The battery pack described here is a battery pack (a so-called soft pack) including one secondary battery, and is to be mounted on, for example, electronic equipment typified by a smartphone.

As illustrated in FIG. 5, the battery pack includes an electric power source 111 and a circuit board 116. The circuit board 116 is coupled to the electric power source 111, and includes a positive electrode terminal 125, a negative electrode terminal 127, and a temperature detection terminal 126.

The electric power source 111 includes one secondary battery. The secondary battery has a positive electrode lead 25 coupled to the positive electrode terminal 125 and a negative electrode lead 26 coupled to the negative electrode terminal 127. The electric power source 111 is couplable to outside via the positive electrode terminal 125 and the negative electrode terminal 127, and is thus chargeable and dischargeable via the positive electrode terminal 125 and the negative electrode terminal 127. The circuit board 116 includes a controller 121, a switch 122, a PTC device 123, and a temperature detector 124. However, the PTC device 123 may be omitted.

The controller 121 includes, for example, a central processing unit (CPU) and a memory, and controls an overall operation of the battery pack. The controller 121 detects and controls a use state of the electric power source 111 on an as-needed basis.

If a voltage of the electric power source 111 (the secondary battery) reaches an overcharge detection voltage or an overdischarge detection voltage, the controller 121 turns off the switch 122. This makes it possible to prevent a charging current from flowing into a current path of the electric power source 111. The overcharge detection voltage and the overdischarge detection voltage are not particularly limited. For example, the overcharge detection voltage is 4.2 V ± 0.05 V and the overdischarge detection voltage is 2.4 V ± 0.1 V.

The switch 122 includes, for example, a charge control switch, a discharge control switch, a charging diode, and a discharging diode. The switch 122 performs switching between coupling and decoupling between the electric power source 111 and external equipment in accordance with an instruction from the controller 121. The switch 122 includes, for example, a metal-oxide-semiconductor field-effect transistor (MOSFET). The charging and discharging currents are detected based on an ON-resistance of the switch 122.

The temperature detector 124 includes a temperature detection device such as a thermistor. The temperature detector 124 measures a temperature of the electric power source 111 using the temperature detection terminal 126, and outputs a result of the temperature measurement to the controller 121. The result of the temperature measurement to be obtained by the temperature detector 124 is used, for example, in a case where the controller 121 performs charge/discharge control on the electric power source 111 upon abnormal heat generation or in a case where the controller 121 performs a correction process regarding a remaining capacity of the electric power source 111 upon calculating the remaining capacity.

### EXAMPLES

Referring to Examples and comparative examples, a description is given in more detail below of the secondary battery according to an embodiment. Note that Examples described below are merely examples of the secondary battery according to an embodiment. The present technology is therefore not limited to Examples described herein.

### Manufacture of Negative Electrode

First, 99 mass% of Si powder and 1 mass% of a polyurethane resin were mixed with an appropriate amount of pure water and the mixture was sufficiently stirred. Thereafter, the mixture was sprayed and dried by means of a spray dryer to thereby obtain Si composite secondary particles which are the Si-based negative electrode active material. The Si composite secondary particles (the Si-based negative electrode active material) of each of Examples and comparative examples were manufactured under conditions described in Table 1 by changing conditions including, without limitation, a raw material and a mixture ratio.

The polyurethane resin described above is a compound generated from a polyolefin-based polyol and a polyisocyanate, except for some cases. Specifically, the polyolefin-based polyol is a compound including a hydroxyl group among: polymers and copolymers of any of diolefins each having carbon number of greater than or equal to 4 and less than or equal to 12; and a copolymer of a diolefin having carbon number of greater than or equal to 4 and less than or equal to 12 and any of α-olefins each having carbon number of greater than or equal to 2 and less than or equal to 22. The polyisocyanate compound includes one or more of an aromatic polyisocyanate, an aliphatic polyisocyanate, and an alicyclic polyisocyanate. An average molecular weight of the polyurethane resin was set to 3000, 10000, or 50000. Note that the polyurethane-resin may be synthesized in advance and thereafter mixed with the Si powder, or may be mixed with the Si powder together with the polymerization initiator, to be polymerized and synthesized by heat at the time of drying.

Thereafter, 10 mass% of the Si composite secondary particles, 85 mass% of graphite (MesoCarbon MicroBeads: MCMB) which is the carbon-based negative electrode active material, 4 mass% of the negative electrode binder, and 1 mass% of MWCNT (MultiWall Carbon NanoTube) which is the negative electrode conductor were mixed with an appropriate amount of N-methyl-2-pyrrolidone (NMP), following which the mixture was kneaded and stirred by means of a planetary centrifugal mixer to thereby obtain a negative electrode mixture slurry.

In addition, a negative electrode mixture slurry of each of Examples and the comparative examples was manufactured under conditions described in Table 1 by changing conditions including, without limitation, a raw material and a mixture ratio.

Thereafter, the manufactured negative electrode mixture slurry was uniformly applied on each of opposite sides of a copper foil having a thickness of 8 µm. The copper foil on which the negative electrode mixture slurry was applied was dried with warm air and thereafter compression-molded by means of a roll pressing machine to form a negative electrode sheet. Further, the negative electrode sheet was cut into a band shape of 72 mm × 810 mm to thereby manufacture a negative electrode. Thereafter, the negative electrode lead was attached to the negative electrode at an exposed portion of the copper foil.

### Manufacture of Positive Electrode

Ninety-five mass% of lithium cobalt oxide which is the positive electrode active material, 2 mass% of amorphous carbon powder (Ketjen black), and 3 mass% of polyvinylidene difluoride (PVDF) were mixed with each other to prepare a positive electrode mixture, and the prepared positive electrode mixture was dispersed in NMP to thereby obtain a positive electrode mixture slurry.

Thereafter, the positive electrode mixture slurry was uniformly applied on each of opposite sides of a band-shaped aluminum foil having a thickness of 10 µm. The aluminum foil on which the positive electrode mixture slurry was applied was dried with warm air and thereafter compression-molded by means of a roll pressing machine to form a positive electrode sheet. Further, the positive electrode sheet was cut into a band shape of 70 mm × 800 mm to thereby manufacture a positive electrode. Thereafter, the positive electrode lead was attached to the positive electrode at an exposed portion of the aluminum foil.

Note that, other than the lithium cobalt oxide described above, any of various positive electrode active materials including, without limitation, lithium nickel cobalt aluminum oxide (NCA) and lithium nickel cobalt manganese oxide (NCM) may be used as the positive electrode active material in a similar manner.

### Manufacture of Electrolytic Solution

Lithium hexafluoride phosphate (LIPF₆) as the electrolyte salt was dissolved in a solvent to achieve a concentration of 1.0 mol/L, to thereby fabricate the electrolytic solution. The solvent included ethylene carbonate (EC) and ethyl methyl carbonate (EMC) that were mixed with each other at a mass ratio of 5:5.

### Manufacture of Secondary Battery

Thereafter, the positive electrode and the negative electrode manufactured above were brought into close contact with each other with a separator interposed therebetween. The separator included a microporous polyethylene film having a thickness of 25 µm. The positive electrode, the negative electrode, and the separator were wound in a longitudinal direction, and a protective tape was attached at an outermost part thereof to thereby manufacture a wound electrode body. Thereafter, the wound electrode body was sandwiched by the outer package member, and three sides of the outer package member corresponding to an outer circumference of the wound electrode body were subjected to thermal-fusion-bonding. As the outer package member, a moisture-proof aluminum laminated film was used. The moisture-proof aluminum laminated film included a nylon film having a thickness of 25 µm, an aluminum foil having a thickness of 40 µm, and a polypropylene film having a thickness of 30 µm that were laminated in this order from an outermost layer. Thereafter, the electrolytic solution was injected from an opening on one side of the outer package member, and the opening of the one side of the outer package member was subjected to thermal-fusion-bonding under a reduced pressure. The secondary battery was manufactured by the processes described above.

### Design of Secondary Battery

The secondary battery was designed as follows. First, a one-side coated sample of the positive electrode and a one-side coated sample of the negative electrode were separately fabricated to thereby fabricate respective coin cells for the positive electrode and the negative electrode each including a counter electrode of Li. Thereafter, the coin cell including the positive electrode and Li was charged with a constant current of 0.1 C until a voltage reached an initial charge voltage of 4.45 V, and was thereafter charged with a constant voltage until a value of a current became ⅒ of the value of the constant current. An electric capacity at that timing was measured. Further, the coin cell including the negative electrode and Li was charged with a constant current of 0.1 C until a voltage reached an initial charge voltage of 0 V, and was thereafter charged with a constant voltage until a value of a current became ⅒ of the value of the constant current. An electric capacity at that timing was measured.

A charge capacity per mixture thickness of each of the positive electrode and the negative electrode was thereby calculated. With use of the calculated values, respective thicknesses of the positive electrode active material layer and the negative electrode active material layer were set in such a manner that the charge capacity of the positive electrode with respect to the charge capacity of the negative electrode became 0.9. The thicknesses of the positive electrode active material layer and the negative electrode active material layer were adjusted by solid contents and application speeds of the positive electrode mixture slurry and the negative electrode mixture slurry, respectively.

### Evaluation

Under an environment at 23° C., the secondary battery fabricated by the above-described processes was charged with a constant current of 0.2 C until a battery voltage reached 4.40 V, and was thereafter charged with a constant voltage of 4.40 V until a value of a current reached 0.025 C. Thereafter, the secondary battery was discharged with a constant current of 0.2 C until the battery voltage reached 3.0 V (initial charging and discharging).

After the initial charging and discharging described above was performed, charging and discharging was performed repeatedly for a second cycle to a 100th cycle under the following conditions. Specifically, under an environment at 23° C., the secondary battery was charged with a constant current of 0.5 C until the battery voltage reached 4.40 V, and was thereafter charged with a constant voltage of 4.40 V until the value of the current reached 0.025 C, following which the secondary battery was discharged with a constant current of 0.5 C until the battery voltage reached 3.0 V. Such charging and discharging was counted as one cycle, and 100 cycles of charging and discharging were performed. The cyclability characteristic was calculated by dividing a 100th-cycle discharge capacity by a second-cycle discharge capacity. Note that because a battery characteristic depends greatly on an amount of the Si-based negative electrode active material, Table 1 below presents the cyclability characteristic in a relative value where a value of corresponding one of comparative examples fabricated with respective different amounts of the Si-based negative electrode active material is assumed as 100.

The recovery was calculated as follows in accordance with JIS6251. Specifically, each of the materials was dried and punched into the shape of the dumb-bell No. 8 having a thickness of 20 µm (with a middle part having a length of 16 mm). Each of the materials having the shape of the dumb-bell No. 8 was stretched by a tensile test machine by 100% (until the length of the middle part reached 32 mm), following which the length of the middle part after the stretching was measured. Based on a result of the measurement, the recovery was calculated by the following expression.

$$\begin{matrix}\text{Recovery} \left(\%\right) = \\ \left(\text{32 mm} - \text{length of middle part after stretching}\right) / \text{16 mm} \times \text{100} \text{.}\end{matrix}$$

Note that a recovery of polyimide was not measured because it is difficult to stretch polyimide by 100%.

The elastic modulus was measured by nanoindentation. The nanoindentation is a measurement method of calculating a mechanical property such as the elastic modulus from a load-displacement curve by pushing a diamond indenter into an object to be measured and measuring a load and a displacement at the time of pushing. The use of the nanoindentation allows for highly accurate measurement of the elastic modulus of a thin film. A nanoindenter is known as equipment to perform the nanoindentation. The nanoindenter includes a transducer, a controller, and a personal computer. The transducer and the controller control the diamond indenter and detect a measured value. The personal computer is used for operations.

Specifically, a solution of each of the materials was applied on a substrate such as a silicon wafer by means of a machine such as a spin coater to provide a thin film having a film thickness of 1 µm after the applied solution was dried. The nanoindenter was pressed against the thin film to thereby measure the elastic modulus. For the pressing, a diamond indenter having a length of 20 µm per side and having a flat-shaped tip was used. The elastic modulus was calculated from a load-displacement curve in a case where such a diamond indenter was displaced down to an indentation depth of 200 nm.

Respective words in Table 1 represent the following materials.
PU1: a polyurethane resin of a polyolefin-based polyol and a polyisocyanate, having an average molecular weight of 3000
PU2: a polyurethane resin of a polyolefin-based polyol and a polyisocyanate, having an average molecular weight of 10000
PU3: a polyurethane resin of a polyolefin-based polyol and a polyisocyanate, having an average molecular weight of 50000
PU4: a polyurethane resin of a polycarbonate-based polyol and a polyisocyanate, having an average molecular weight of 3000
PVDF: polyvinylidene difluoride
SPA: sodium polyacrylate
LPA: lithium polyacrylate
PAA: polyacrylamide
PI: polyimide
AR: aramid
SBR: styrene-butadiene rubber
MWCNT: multi-walled carbon nanotube
SWCNT: single-walled carbon nanotube

Based upon the result presented in Table 1, the secondary batteries according to Examples 1 to 14 had respective cyclability characteristics higher than those of the secondary batteries according to Comparative examples 1 to 4.

As compared with the secondary batteries according to Comparative examples 2 and 4, each of the secondary batteries according to Examples 1 and 2 used an organic resin having a recovery of 70% or higher as the covering material, and therefore had a higher cyclability characteristic. A reason for this is as follows. In a case where the organic resin included in the covering material had a low recovery, at a time when the active material core expanded and thereafter contracted, the negative electrode active material layer was not recovered to its original state. The negative electrode active material layer thus expanded gradually with the proceeding of cycles of charging and discharging. This prevented the Si-based negative electrode active materials from easily coming into contact with each other and gradually made it difficult to obtain the capacity.

As compared with the secondary battery according to Comparative example 3, the secondary battery according to Example 1 used, as the negative electrode binder, a material having an elastic modulus higher than that of the organic resin included in the covering material, and therefore had a higher cyclability characteristic. A reason for this is as follows. Using, as the negative electrode binder, the material having the elastic modulus higher than that of the organic resin included in the covering material increased stiffness of the negative electrode active material layer as a whole. This made it possible to suppress expansion of the negative electrode active material layer accompanying the proceeding of cycles of charging and discharging.

As compared with the secondary battery according to Example 1, each of the secondary batteries according to Examples 7 and 8 further used the surface conductor, and therefore had a higher cyclability characteristic. A reason for this is as follows. The surface conductor allowed coupling between the primary particles or the secondary particles of the Si-based negative electrode active material to be firmer. This helped to prevent the Si-based negative electrode active material from collapsing due to expansion and contraction, thus making it possible to more firmly maintain an electrically conductive network. Another reason is that the surface conductor was able to decease the electric resistance, of the Si-based negative electrode active material, which had increased due to the covering material, therefore making it possible to suppress a decrease in cyclability characteristic that was to be caused by an increase in resistance of the Si-based negative electrode active material.

In addition, the secondary battery according to Example 15 had a higher cyclability characteristic, as compared with a secondary battery according to Comparative example 5. The secondary battery according to Example 16 had a higher cyclability characteristic, as compared with a secondary battery according to Comparative example 6. The secondary battery according to Example 17 had a higher cyclability characteristic, as compared with a secondary battery according to Comparative example 7. That is, effects of the present technology were similarly exhibitable also in a case where a ratio of the Si-based negative electrode active material to the carbon-based negative electrode active material was changed.

Although the present technology has been described above with reference to one or more embodiments including Examples, the configuration of the present technology is not limited thereto, and is therefore modifiable in a variety of suitable ways.

For example, although the description has been given of the case where the battery device has a device structure of a wound type (the wound electrode body), the device structure of the battery device is not particularly limited. Accordingly, the device structure of the battery device may be any other device structure, such as a device structure of a stacked type in which the electrodes (the positive electrode and the negative electrode) are stacked on each other (a stacked electrode body), or a device structure of a zigzag folded type in which the electrodes (the positive electrode and the negative electrode) are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

1. A secondary battery comprising:
a positive electrode;
a negative electrode including a silicon-based negative electrode active material and a negative electrode binder; and
an electrolytic solution, wherein
the silicon-based negative electrode active material includes an active material core and a covering material, the active material core including a silicon-containing compound, the covering material covering at least a portion of a surface of the active material core,
the negative electrode binder has an elastic modulus higher than an elastic modulus of the covering material,
the covering material has an elongation at break of 100 percent or higher, and has a recovery of 70 percent or higher after being stretched to an elongation at break of 100 percent.

2. The secondary battery according to claim 1, wherein the covering material comprises a polyurethane resin having an average molecular weight of 10000 or less.

3. The secondary battery according to claim 2, wherein the polyurethane resin comprises a polymer of a polyolefin-based polyol and a polyisocyanate.

4. The secondary battery according to claim 1, wherein the negative electrode binder includes at least one of polyvinylidene difluoride, a polyacrylic acid salt, polyimide, aramid, polyacrylamide, or a styrene-butadiene rubber.

5. The secondary battery according to claim 1, wherein the silicon-based negative electrode active material further includes a surface conductor covering at least a portion of the surface of the active material core.

6. The secondary battery according to claim 1, wherein the negative electrode further includes a carbon-based negative electrode active material.

7. The secondary battery according to claim 1, wherein the secondary battery comprises a lithium-ion secondary battery.
